(19) United States
(12) Patent Application Publication
(10) Pub. No.: US 2025/0111473 A1
(43) Pub. Date: Apr. 3, 2025

(54) SAMPLE ADAPTIVE X-RAY MICROSCOPY RESOLUTION RECOVERY

(71) Applicant: CARL ZEISS X-RAY MICROSCOPY, INC., Dublin, CA (US)

(72) Inventors: Matthew ANDREW, Livermore, CA (US); Yan LIU, Pleasanton, CA (US); Andriy ANDREYEV, Dublin, CA (US); Lars OMLOR, Nuremberg (DE)

(21) Appl. No.: 18/725,443

(22) PCT Filed: Dec. 22, 2022
(86) PCT No.: PCT/US2022/082254

§ 371 Date: Jun. 28, 2024

Related U.S. Application Data
(60) Provisional application No. 63/294,448, filed on Dec. 29, 2021.

(51) Int. Cl. G06T 3/4046; G06T 3/4053; G06T 5/50; G06T 5/60; G06T 7/30

(52) U.S. Cl. CPC G06T 3/4046; G06T 3/4053; G06T 5/50; G06T 5/60; G06T 7/30; G06T 2207/10056; G06T 2207/10116; G06T 2207/20081; G06T 2207/20084

(57) ABSTRACT

Improvements in image quality can be obtained by leveraging non-linear neural-network based feature recovery across multiple imaging modalities. Input imaging data is acquired, including first imaging data and second imaging data acquired using different imaging modalities. The first imaging data can have lower image quality and a larger FOV than the second imaging data. The first and second imaging data can be aligned and the aligned regions can be used to train a neural network to minimize the difference between the second imaging data and output data processed from the overlapping portion of the first imaging data. Once trained, the neural network can be used to generate improved image quality output from all of the first imaging data.

### CROSS-REFERENCE TO RELATED APPLICATIONS

This application claims benefit and priority of U.S. Provisional Application No. 63/294,448 filed on Dec. 29, 2021, the contents of which is incorporated herein by reference in its entirety.

### TECHNICAL FIELD

The present disclosure relates to X-ray imaging generally and more specifically to image quality improvements in X-ray microscopy.

### BACKGROUND

X-ray Microscopy Imaging is a field of imaging that is used to acquire imaging data for many different types of samples across many different use cases. X-ray Microscopy Imaging has found uses in biology (e.g., imaging biomaterials, soft tissues, and the like), material science (e.g., imaging the internal microstructure of a material), manufacturing (e.g., non-destructively imaging internal components), and many other fields. Individual images (e.g., projections) can be acquired by directing radiation from an X-ray source, through a sample, towards a detector. Multiple projections can be acquired for a single sample by rotating the direction of travel of the X-ray radiation with respect to the sample (e.g., rotating the X-ray source and detector with respect to the sample). Often, the acquired imaging data (e.g., containing multiple projections) is used to generate a three dimensional reconstructed volumes of the sample that was imaged, such as through the use of computed tomography (CT).

While X-ray Microscopy provides many benefits, one challenge is that of scale. Often, the resolution required to image fundamental structures comes at the expense of a field of view required to image an entire sample. Furthermore, high-resolution tomography acquisition tends to be extremely slow, especially for interiors of large samples. While high-resolution detectors exist, they are typically significantly less sensitive than low-resolution detectors, especially to high-energy X-rays. Also, high-resolution sources are typically significantly less powerful than low-resolution sources. When interior tomography occurs within a large sample, the relatively large amount of material outside the field of view can project into the volume, effectively adding noise and artifacts. The non-imaged regions of the sample can act as an X-ray filter, biasing the X-ray spectrum to higher energies, which can be especially problematic when interior tomography occurs within a large sample. Since the high-resolution detectors are not as sensitive to high-energy X-rays, the resultant projections can be noisy. Even if multiple imaging parameters and/or equipment are capable of generating images with the same resolution, the specific imaging parameters and/or equipment may result in images of different quality, such as images with better or worse sharpness, noise, artifacts, point spread function, and the like.

Currently, when imaging is required of a large field of view, there are only two options. The first option is to rely on low-image-quality acquisition techniques, which can achieve a large field of view, but at the expense of image quality (e.g., at the expense of image resolution, image sharpness, image noise, and the like), which can make important features undistinguishable or can otherwise be undesirable. If a high-quality image is required of a large field-of-view, large area composite projections can be created and subsequently reconstructed from two projections offset with respect to each other. However, such acquisition modes are generally prohibitively slow and unreliable.

There is a need for techniques that allow for imaging with both high image quality and large field-of-view. There is also a need for techniques to obtain such imaging at relatively rapid speeds and in a reliable fashion.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, supplemented by this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Embodiments of the present disclosure include a method comprising receiving first imaging data associated with a sample. The first imaging data is acquired using a first imaging modality. The method further comprises receiving second imaging data associated with the sample. The second imaging data is acquired using a second imaging modality that is different than the first imaging modality. The method further comprises aligning the first imaging data and the second imaging data. The method further comprises identifying a portion of the first imaging data overlapping with the second imaging data. The method further comprises training a neural network based at least in part on the portion of the first imaging data and the second imaging data. The method further comprises generating output imaging data by applying the trained neural network to the first imaging data, including those regions that were outside overlapping region with the second imaging data. The trained neural network can now also be applied to other imaging data (e.g., third imaging data) acquired in a manner similar to the first imaging data acquisition and image similar sample class.

In some cases, the first imaging data is associated with a first image quality, the second imaging data is associated with a second image quality, and the output imaging data is associated with a third image quality that is improved with respect to the first image quality. In some cases, the first image quality is associated with a first objective measurement, the second image quality is associated with a second objective measurement, and the third image quality is associated with a third objective measurement that is i) between the first objective measurement and the second objective measurement, or ii) the same as the second objective measurement. In some cases, the first imaging data is acquired at a first resolution and first field of view, the second imaging data is acquired at a second resolution that is higher than the first resolution and a second field of view that is smaller than the first field of view, and the output imaging data has a higher resolution than the first resolution. In some cases, the first imaging modality and the second imaging modality share a common major imaging modality. In some cases, the first imaging modality includes a first major imaging modality that is X-ray microscopy, and the second imaging modality includes a second major imaging modality that is not X-ray microscopy.

In some cases, the method further comprises automatically applying a 3, 6, or 9 degree of freedom sub-pixel alignment to at least one of the first imaging data and the second imaging data to align the first imaging data and the second imaging data. In some cases, the method further comprises resampling at least a portion of the first imaging data onto a grid of the second imaging data. In some cases, training the neural network includes: providing the portion of the first imaging data associated with the second imaging data to the neural network to generate the output data; and adjusting the neural network to reduce a difference between the generated output data and the second imaging data. In some cases, the neural network is based on a u-net neural network. In some cases, generating the output imaging data includes: applying a zoom transform to the first imaging data to achieve an effective pixel size equal to the pixel size of the second imaging data; applying the transformed first imaging data to the trained neural network to generate the output imaging data. In some cases, generating the output imaging data includes: segmenting the first imaging data into a plurality of chunks, wherein each chunk includes at least one overlapping region with an adjacent chunk; applying each of the plurality of chunks of the first imaging data to the trained neural network to generate a corresponding chunk of the output imaging data; and stitching together the overlapping regions of the corresponding chunks of the output imaging data. In some cases, generating the output imaging data includes: receiving a target region selection, wherein the target region selection is indicative of a target region of the first imaging data; tagging the target region with metadata indicative of the location of the target region; applying the first imaging data associated with the target region to the trained neural network to generate a corresponding target region of the output imaging data; tagging the corresponding target region of the output imaging data with the metadata associated with the target region; and positioning the corresponding target region of the output imaging data based at least in part on the metadata.

In some cases, the method further includes identifying a plurality of variation regions associated with the sample, wherein training the neural network and generating the output is associated with a first variation region and is performed using first subsets of the first imaging data and the second imaging data associated with the first variation region. In some cases, the method further includes training a second neural network based at least in part on second subsets of the first imaging data and the second imaging data associated with a second variation region; generating second output imaging data associated with the second variation region by applying the trained second neural network to the subset of the first imaging data associated with the second variation region; and stitching together the output imaging data and the second output imaging data.

In some cases, the method further comprises generating a two-dimensional image or three-dimensional volume using the output imaging data. In some cases, the generated two-dimensional image or three-dimensional volume is generated using the output imaging data and the first imaging data such that at least a region of the two-dimensional image or three-dimensional volume is based on the output imaging data and at least a different region of the two-dimensional image or three-dimensional volume is based on the first imaging data.

Embodiments of the present disclosure include a computer-program product tangibly embodied in a non-transitory machine-readable storage medium, including instructions configured to cause a data processing apparatus to perform any of the aforementioned methods.

Embodiments of the present disclosure include a system comprising: one or more data processors; and a non-transitory computer-readable storage medium containing instructions which, when executed on the one or more data processors, cause the one or more data processors to perform any of the aforementioned methods.

### BRIEF DESCRIPTION OF THE DRAWINGS

The specification makes reference to the following appended figures, in which use of like reference numerals in different figures is intended to illustrate like or analogous components.

FIG. 1 is a schematic diagram depicting an imaging data processing system, according to certain aspects of the present disclosure.

FIG. 2 is a schematic diagram depicting imaging data being used to train a neural network and obtain high-resolution, output imaging data, according to certain aspects of the present disclosure.

FIG. 3 is a flowchart depicting a process for processing imaging data, according to certain aspects of the present disclosure.

FIG. 4 is a schematic diagram of a graphical user interface depicting first and second imaging data, according to certain aspects of the present disclosure.

FIG. 5 is a schematic diagram of a graphical user interface for aligning first and second imaging data, according to certain aspects of the present disclosure.

FIG. 6 is a portion of a low-resolution image, according to certain aspects of the present disclosure.

FIG. 7 is a portion of a high-resolution image, according to certain aspects of the present disclosure.

FIG. 8 is a portion of an improved-image-quality image, according to certain aspects of the present disclosure.

FIG. 9 is a combination image depicting a three-dimensional volume and corresponding two-dimensional image from below for selecting regions for image quality improvement processing, according to certain aspects of the present disclosure.

FIG. 10 is a combination image depicting a three-dimensional volume and corresponding two-dimensional image from below containing a region of improved-image-quality imaging data, according to certain aspects of the present disclosure.

FIG. 11 is a block diagram depicting an example system architecture for implementing certain features and processes of the present disclosure.

### DETAILED DESCRIPTION

Certain aspects and features of the present disclosure relate to a technique to achieve high-image-quality (e.g., high-resolution and large field-of-view (FOV)) X-ray Microscopy imaging data by leveraging non-linear neural-network based feature recovery across multiple imaging modalities (e.g., across multiple major imaging modalities or across multiple minor imaging modalities within a single major imaging modality). Input imaging data is acquired, including first imaging data and second imaging data, using first and second imaging modalities, respectively. For example, the first imaging data can be of a lower resolution and have a larger FOV than the second imaging data, which can be of higher resolution and have a smaller FOV. The first and second imaging data can be aligned and the aligned regions can be used to train a neural network to minimize the difference between the second imaging data and output data processed from the first imaging data. Once trained, the neural network can be used to generate high-image-quality output from all of the first imaging data, resulting in high-image-quality images covering the entire, large FOV imaging data. Any other data generated similarly to the first image data and utilizing similar sample class can be improved by this trained network.

As used herein, the term imaging modality is inclusive of major imaging modalities (e.g., different fundamental techniques for acquiring imaging data, such as X-ray microscopy, optical microscopy, electron microscopy, and the like) and minor imaging modalities (e.g., different types of imaging techniques within a single major imaging modality, such as different scanning parameters of a single instrument or different instruments operating under the same fundamental imaging technique). For example, under the major imaging modality of X-ray imaging, some possible minor imaging modalities may include X-ray imaging using different-resolution detectors, X-ray imaging using scintillators of different sizes, X-ray imaging using different scanning recipes, and the like). Thus, imaging techniques that are of two different modalities may be imaging techniques that are of two different major imaging modalities or imaging techniques that are of the same major imaging modality, but of two different minor imaging modalities.

During X-ray Microscopy procedures, radiation is emitted from one or more emitters (X-ray sources) and is directed to one or more detectors. A sample (e.g., a subject being analyzed) located between the emitter(s) and detector(s) can affect the amount of radiation received by the detector(s), such as by absorbing, reflecting, or otherwise affecting the radiation incident on and/or passing through the sample. The resultant information collected by the detector(s) can be known as data or imaging data. As used herein, the terms scan or scanning can refer to the acquisition of imaging data, optionally during movement of the sample with respect to the emitter(s) and/or detector(s). As used herein, the term computed tomography (CT) is intended to include the use of X-ray imaging data to generate a three-dimensional reconstructed volume of a sample. A three-dimensional reconstructed volume can be a data set indicative of the three-dimensional structure or a three-dimensional image of the sample (e.g., a three-dimensional image composed of voxels). X-ray imaging is generally non-destructive to the sample.

Electron microscopy (EM) is a different major imaging modality that makes use of a beam of accelerated electronics directed towards a sample to image the sample. Different minor imaging modalities of electron microscopy include techniques such as transmission electron microscopy (TEM), scanning electron microscopy (SEM), reflection electron microscopy (REM), and the like. EM imaging is generally collected for individual slices of a sample or an exposed surface of a sample. In some cases, multiple slices of EM images can be combined to achieve a three-dimensional reconstructed volume. EM imaging can achieve very high-quality images in some circumstances, but acquisition of such images is often very time-consuming and costly. Additionally, EM imaging is often destructive to the sample.

Optical microscopy (OM) is a different major imaging modality that makes use of light (e.g., visible or non-visible light) reflecting from or passing through a sample to image the sample. Different minor imaging modalities of optical microscopy include techniques such as stereo microscopy, confocal microscopy, bright field microscopy, dark field microscopy, and the like. OM is generally used to inspect a surface of a sample. Image quality and time/cost expended to acquire images can vary depending on the types of samples imaged and the types of optical microscopy techniques employed. Generally, optical microscopy is non-destructive to the sample.

Certain aspects and features of the present disclosure can be used to generate improved imaging data, which can result in improved two-dimensional images, improved three-dimensional volumes (e.g., improved CT reconstructed volumes), or other improved images or volumes (e.g., laminography reconstructions) reliant upon the imaging data.

Deep neural networks (DNNs) can be used to generate or improve imaging data or a reconstructed volume, but must be properly trained. A DNN trained on a training subject may not perform well on a different sample, especially if the subject and the sample are different types of samples (e.g., different materials or a substantially different structural makeup) or if the imaging geometry and/or X-ray source setting differs significantly from that used in acquiring the training data.

Certain aspects and features of the present disclosure make use of a modified U-net, although any other suitable neural network architecture can be used (e.g., a residual neural network, a SqueezeNet neural network, and the like). A U-net is a modified version of a convolutional neural network (CNN) that includes upsampling operators to achieve an output with a higher resolution than achieved by a traditional CNN (e.g., an output with a resolution the same as or higher than the input resolution). In some cases, the U-net can be modified to work in both 2 and 2.5 dimensions. For example, the 2.5D U-net can use a non-isotropic slice through the data of shape A×B×5 as the input, producing a result of shape (A−186)×(B−186)×3 as the output.

Certain aspects and features of the present disclosure can achieve various image quality improvements, such as super-resolution (e.g., resolution increased beyond the resolution of the input data), improved sharpness, improved point spread function, improved signal-to-noise ratio, and decreased artefacts (e.g., especially if imaging artefacts are uncorrelated between the first and second input imaging data). For example, detector noise that is uncorrelated between first and second input imaging data can result in a trained neural network that has a denoising effect, such that the output imaging data is denoised. Additional effects or imaging imperfections that could be further improved include limited angle or sparse angular sampling artefacts, beam hardening artefacts, and the like. In some cases, the second imaging data can be acquired in a fashion (e.g., a particular minor imaging modality or major imaging modality) that is selected to avoid or minimize certain artefacts or other problems known to occur in the first imaging data.

According to certain aspects of the present disclosure, input imaging data is acquired, including first imaging data acquired according to a first imaging modality (e.g., a first major imaging modality and a first minor imaging modality) and second imaging data acquired according to a second imaging modality (e.g., a second major imaging modality that is different from the first major imaging modality or a second minor imaging modality of the first major imaging modality that is different from the first minor imaging modality). The terms “first” and “second” with respect to imaging data are intended to differentiate the two sets of imaging data, and not necessarily indicate an order in which the imaging data is acquired. In some cases, second imaging data is acquired before first imaging data. The first imaging data can be of a larger field of view than the second imaging data and/or can be associated with a greater area or volume of the sample than the second imaging data. The second imaging data, however, can be of a different imaging modality capable of obtaining higher-quality imaging (e.g., higher resolution, improved sharpness, improved point spread function, and the like). In some cases, both the first imaging data and second imaging can be of the same-sized field of view, such as in cases where the low resolution imaging data was achieved by having the detector integrate the signal over a larger area to obtain low resolution low noise fast acquisition data.

The first and second imaging data is acquired of the same sample, and can be acquired with the sample being supported by a single sample holder. The sample holder can define known registration points to facilitate registration and/or alignment of the first and second imaging data. In some cases, the sample holder can be incorporated into the same instrument used to acquire both the first and second imaging data, which can further facilitate registration and/or alignment.

In an example, acquiring the input imaging data can include acquiring automatically registered low-resolution and high-resolution imaging data, such as through a Scout-and-Zoom process as available on ZEISS® X-ray microscopy instruments, such as the Xradia Versa® instrument. A low-resolution, large FOV image can be performed initially, permitting the system to define a particular region of interest (e.g., as defined by a user or automatically determined by the system using the low-resolution imaging data) and capture corresponding high-resolution imaging data. The low-resolution and high-resolution imaging data can be aligned using the relative stage positions (e.g., XYZ stage positions) of the two tomographies, since the coordinate system of the calibrated stage's positioning is known with respect to the instrument. In some cases, sub-pixel alignment can be performed, such as using automatic 3, 6, or 9 degree of freedom sub-pixel alignment.

Input imaging data, including first imaging data, second imaging data, or both first and second imaging data, can be pre-processed. Pre-processing imaging data can include registering, aligning, resampling, and/or otherwise modifying imaging data. Pre-processing steps can be performed in any suitable order. In some cases, registering or aligning imaging data can include coordinate transformation, warpage removal, and/or distortion removal.

Registration and/or alignment can be performed between the first and second imaging data. When possible, registration and/or alignment can be facilitated with the known registration points or fiducial markers established by the use of a common sample holder. The common sample holder can define a known coordinate system in which the sample is positioned and located, permitting registration and/or alignment based on the known coordinate system. The sample may be positioned and located in the same position and location within that coordinate system despite imaging data being acquired using different imaging modalities and even different instruments, as long as the sample remains held by the sample holder. In some cases, additional registration and/or alignment techniques as disclosed herein can be used in addition to the use of a common sample holder. When use of a common sample holder is not possible or practical, such as when image data are acquired using multiple modalities that preclude use of a common sample holder (e.g., certain multiple major imaging modalities, such as certain X-ray and electron microscopy imaging techniques), registration and/or alignment can be performed using any other suitable techniques.

In some cases, a machine learning model can be trained to facilitate registration of imaging data acquired using one imaging modality to imaging data acquired using a different imaging modality. Such machine learning registration techniques can be trained using unsupervised training data of multiple different samples acquired using different pairs of imaging modalities. Thus, trained machine learning models can be stored for registration and/or alignment of imaging data for different combinations of modalities (e.g., a first model for registering transmission electron microscopy imaging data to X-ray imaging data, a second model for registering scanning electron microscopy imaging data to X-ray imaging data, and a third model for registering optical microscopy imaging data to X-ray imaging data). In some cases, each trained machine learning model can be specific to a direction of registration, such that two separate models can be trained for a pair of imaging modalities (e.g., one model to register imaging data from a first modality to that of a second modality, and a second model to register imaging data from the second modality to that of the first modality). Registration and/or alignment is described herein as being a part of pre-processing of imaging data, but that need not always be the case, and registration and/or alignment can occur before or after any pre-processing of imaging data. Registration and/or alignment can be performed before or after any other pre-processing techniques.

In some cases, one or both of the first and second imaging data can be resampled to match or better match one another. For example, spatially aligned low-resolution imaging data can be resampled (e.g., via interpolation) onto the grid of high-resolution imaging data. Resampling of lower-resolution imaging data to the higher resolution of the high-resolution imaging data, or at least an intermediate resolution between the low resolution of the lower-resolution imaging data and the higher resolution of the high-resolution imaging data, can facilitate training of the neural network used to generate the output imaging data, as well as potentially also facilitating certain pre-processing techniques (e.g., registration and/or alignment).

Further, in some cases, one or both of the first and second imaging data can be modified or otherwise adjusted to appear more similar to one another. For example, when using an X-ray major imaging modality for first imaging data and an electron microscopy major imaging modality for the second imaging data, the second imaging data would appear different than the first imaging data. Thus, the second imaging data may be processed to appear more similar to general X-ray imaging data, such as by applying grayscale, contrast, and other adjustments to the second imaging data. Thus, one or both of the first and second imaging data can be specifically pre-processed in a way that facilitates one of the first and second imaging data in training a neural network used to generate output imaging data from the other of the first and second imaging data.

In an example with multiple major imaging modalities, acquiring the input imaging data can include acquiring first imaging data using an X-ray microscopy instrument, then acquiring second imaging data using an electron microscopy instrument. The first imaging data can be acquired for a large region of the sample (e.g., the entire sample), while the second imaging data can be acquired for specific, smaller region(s) of the sample, such as regions having important features (e.g., inclusions, edges, material changes, and the like). Because of the nature of electron microscopy, the second imaging data would be acquired second, since it would involve cutting the sample. The first imaging data can be X-ray imaging data acquired at first voxel size, such as 300 nm. The second imaging data, however, may be electron microscopy imaging data acquired at a second voxel size, such as 30 nm (e.g., 30 nm slices). In some cases, the second imaging data can be pre-processed by down-sampling to the first voxel size or an intermediate voxel size (e.g., a voxel size between the first voxel size and the second voxel size, such as 200 nm), and then applying modifications to the down-sampled imaging data designed to make the imaging data mimic the imaging modality of the first imaging data (e.g., designed to mimic general X-ray imaging data). These modifications can be pre-programmed or dynamically determined. The second imaging data can be registered and/or aligned with the first imaging data (e.g., before, during, or after other pre-processing steps). The pre-processed and registered/aligned second imaging data can then be used with any overlapping first imaging data to train the neural network to convert first imaging data into output imaging data using the second imaging data as a goal result. Thus, the first imaging data can be used as a low-image-quality (e.g., low-resolution) input and the pre-processed and registered/aligned second imaging data can be used as a high-image-quality (e.g., high-resolution) desired output. Once the neural network is trained, all of the first imaging data can be processed using the trained neural network to generate output imaging data of high image quality for the entire large region of the sample (e.g., the entire sample) for which first imaging data was obtained. In some cases, however, third imaging data can be processed using the trained neural network to generate output imaging data, in which case the third imaging data can be similarly acquired data of a similar sample class to that of the first imaging data.

In an example with multiple minor imaging modalities within the same major imaging modality, first imaging data can be acquired using an X-ray imager having a first scintillator and second imaging data can be acquired using an X-ray imager having a second scintillator that is different than the first scintillator. The first and second scintillator can be different in various ways, such as having different thicknesses. For example, a thinner scintillator may obtain higher resolution imaging data, but a thicker scintillator may result in a brighter image or image with a greater dynamic range (e.g., ratio between maximum and minimum intensities). A neural network can be trained using a portion of the first imaging data and the second imaging data, then the neural network can be applied to the full first imaging data to generate output imaging data that is improved over the other or both of the first and second imaging data (e.g., has a higher resolution than that capable with the thicker scintillator and/or a brighter image or greater dynamic range than that capable with the thinner scintillator). Other differences in scintillators can be used with or instead of scintillator thickness. In other examples, other differences in X-ray detectors and/or emitters, including user-adjustable settings, can be different between acquisitions of the first imaging data and the second imaging data. In some cases, these and other differences can be made while using the same instrument (e.g., same X-ray imager, such as an X-ray imager with multiple detectors), although that need not always be the case, and multiple instruments can be used.

Regardless of how the input imaging data is acquired, the neural network can be trained via any suitable technique using that input imaging data (e.g., the low-image-quality first imaging data and the high-image-quality second imaging data). Two correlated arrays (e.g., a low-resolution array and a high-resolution array based on the low-resolution imaging data and high-resolution imaging data, respectively) can be exported as an input-target pair in a format amenable to a neural network backend. The neural network can then be trained to map the first imaging data (e.g., low-resolution imaging data) to the second imaging data (e.g., high-resolution imaging data). Through training, the neural network will optimize the creation of features as they are exhibited at high image quality based on the input as exhibited at low image quality.

In some cases where a portion of the first imaging data is pre-processed for training the neural network (e.g., transforming low-resolution first imaging data, such as via a zoom transformation, so that the data is interpolated such that its new pixel grid has an effective pixel size equal to the high-resolution second imaging data), the entire first imaging data can be likewise pre-processed before being applied to the trained neural network. In some cases, the first imaging data can be otherwise pre-processed in a different fashion, such as reconstructed onto a grid having a desired pixel size for a desired output resolution that is different than the resolution of the second imaging data. For example, in some cases, significant upsampling (e.g., 4× upsampling, such as by dividing each voxel into 64 pixels) before application of the trained neural network can help improve (e.g., reduce or eliminate) some aliasing artifacts. In some cases, however, first imaging data can be supplied to the trained neural network without any resampling and/or without other pre-processing actions.

In some cases, the entire zoomed 3D dataset can be chunked and fed through the trained neural network. Chunking may be especially useful when computational hardware is limited. Further, the change in shape between the input imaging data and output imaging data must be taken into account. In some cases, regions of overlap may be implemented when chunking the data to allow for stitching of the overlapping regions to best preserve a continuous image.

In some cases, it can be desirable to apply the trained neural network to less than the entire input dataset, such as in cases where faster processing is desired. In such cases, specific regions of the input imaging data can be selected for image quality improvement (e.g., resolution recovery). These targeted regions can be tagged (e.g., with metadata), such as using region targeting software, to denote the 3D position of the regions. The imaging data from these targeted regions can be processed through the neural network to output improved-image-quality imaging data for those targeted regions. Then, the metadata from the targeted regions can be applied to the corresponding improved-image-quality imaging data, permitting the super-resolution imaging data to be re-inserted into the input imaging data in the appropriate position in 3D visualization space.

The trained neural network may not be able to create new information, however it can correlate high-image-quality (e.g., high-resolution) structures with the way those structures are expressed at a lower image quality (e.g., a lower resolution). For example, edges at low resolution reliably code for edges at high resolution. Theoretically, there are many ways of recovering low-resolution information from high-resolution information. If multiple of the many theoretically degenerate options of the high-resolution to low-resolution transform are practically present in the high-resolution dataset and not effectively predicted for by (or correlated with) other local or non-local features in the low-resolution dataset, the network may not be able to learn the transform. Such a state can be considered as a “practically degenerate” state (as opposed to a universal “theoretically degenerate” state always occupied by the relative encoding of two images of the same structures at differing resolutions). The level of practical degeneracy is sample and resolution dependent, but the ratio of practical degeneracy to theoretical degeneracy may always be less than or equal to one, and is often sufficiently small that the image quality improvement techniques (e.g., super-resolution techniques) disclosed herein provide significant benefits and image quality improvements. A ratio of practical degeneracy to theoretical degeneracy can be a technique for evaluating the efficacy of the trained neural network.

Aspects and features of the present disclosure relate to using a trained neural network on first imaging data to generate output imaging data of a higher image quality than the first imaging data. Image quality can be evaluated in numerous ways, depending on the desired outcome and/or specific use case. In some cases, the aspect(s) of image quality to improve can be user-selected, can be dynamically determined based on available input data, or can be preset. Improved image quality can include a measureable, objective improvement (e.g., higher resolution, lower point spread function, etc.) or a subjective improvement (e.g., removed or reduced artifacts, more visible corners and edges, etc.). In an example case, image quality can be resolution, in which case the first imaging data can be of a lower resolution than the second imaging data and the output imaging data. In another example case, image quality can be a point spread function, in which case the first imaging data can have a larger point spread function than that of the second imaging data and the output imaging data. Other examples of aspects of image quality that can be improved include sharpness, noise (e.g., signal-to-noise ratio), dynamic range, contrast, distortion, artifacts, and the like.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

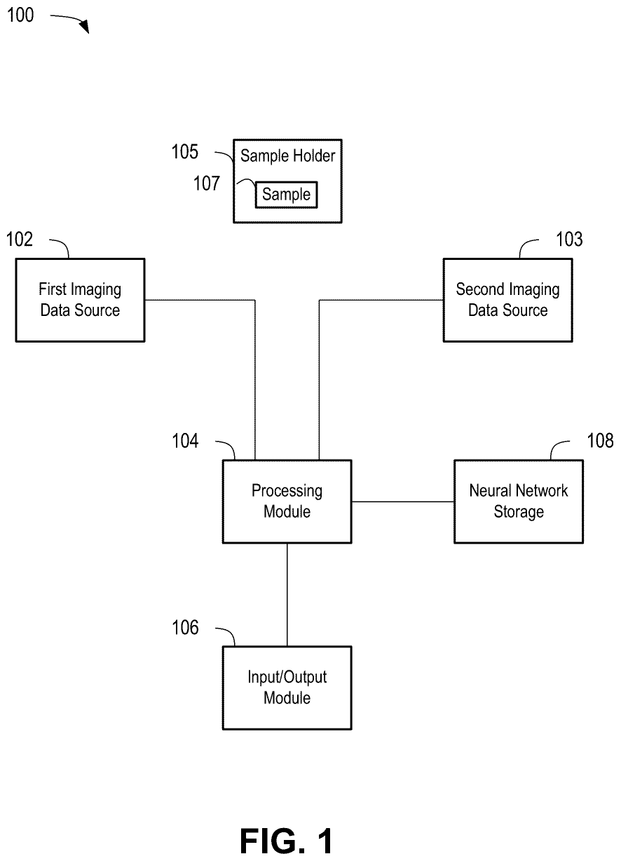

FIG. 1 is a schematic diagram depicting an imaging data processing system 100, according to certain aspects of the present disclosure. The imaging data processing system 100 (e.g., control system) can include a first imaging data source 102 and a second imaging data source 103 that provide imaging data to a processing module 104. Each of the first imaging data source 102 and the second imaging data source 103 can be any suitable source of imaging data, such as an imager (e.g., an imaging machine such as an X-ray microscope, a CT scanner, an electron microscope, an optical microscope, and the like), a database of imaging data, a local memory storing imaging data, a removable memory storing imaging data, or the like. Certain aspects and features of the present disclosure are especially useful when the first imaging data source 102 and second imaging data source 103 are imagers, such as an X-ray microscopes. In some cases, the first imaging data source 102 and second imaging data source 103 are the same instrument (e.g., a single X-ray imager capable of generating both first imaging data and second imaging data). In some cases, the first imaging data source 102 and second imaging data source 103 are different instruments of the same major imaging modality (e.g., first and second X-ray imagers). In some cases, the first imaging data source 102 and second imaging data source 103 are different instruments of different major imaging modalities (e.g., an X-ray imager and an electron microscope).

The first imaging data source 102 and second imaging data sources 103 can provide first and second imaging data, respectively. First and second imaging data can be acquired for a single sample 107, but using different imaging modalities, such as different major imaging modalities (e.g., different types of imaging instruments) or different minor imaging modalities (e.g., different settings or types of equipment within the same major imaging modality). In some cases, the sample 107 can be retained in a sample holder 105 during acquisition of both the first imaging data and the second imaging data. In such cases, known features of the sample holder 105 can be used to facilitate registration and/or alignment of the first and second imaging data. When the first and second imaging data are acquired by the first imaging data source 102 and second imaging data source 103, respectively, the sample 107 can remain in the same position and location with respect to the sample holder 105 during both acquisitions. In some cases this can involve keeping the sample holder 105 in the same instrument to collect both first and second imaging data, although in some cases this can involve moving the sample holder 105 between a first instrument and a second instrument without repositioning the sample 107 with respect to the sample holder 105.

In some cases, first and second imaging data can be acquired for multiple samples being retained by a multi-sample sample holder. In such cases, the first and second imaging data for each sample can be used independently of the first and second imaging data from any other samples, although that need not always be the case.

The processing module 104 can process imaging data from the first imaging data source 102 and second imaging data source 103. In some cases, the processing module 104 can control one or both of the first imaging data source 102 and second imaging data source 103. The processing module 104 can use the imaging data to train a neural network, such as an artificial neural network (ANN) (e.g., a deep neural network (DNN), a convolutional neural network (CNN), or the like), and/or use such a trained neural network to process imaging data into super-resolution imaging data.

In some cases, the processing module 104 can also carry out reconstruction of imaging data (e.g., input imaging data or output imaging data, such as improved-image-quality imaging data) to generate reconstructed volumes (e.g., converting a set of acquired projections into a three-dimensional reconstructed volume). In some cases, the processing module 104 can access a pre-trained neural network from a neural network storage 108, which can be applied as-is or can be further trained. The pre-trained neural network can be trained based on prior scans acquired from the first imaging data source 102 and/or the second imaging data source 103, such as prior scans of the same or a similar object. In some cases, the pre-trained neural network can be a neural network that is generated using a federated learning technique, in which multiple trained neural networks can be collected and combined to generate a collaborative neural network that is distributed as the pre-trained neural network. In such cases, each pre-trained neural network can be associated with the same category of sample and/or the same or similar acquisition parameters, and the pre-trained neural network accessed by the processing module 104 can be accessed based on a provided category and/or set of acquisition parameters. When a pre-trained neural network is used, it can be further trained as disclosed herein with reference to initially training a neural network, such as using low-resolution input imaging data and high-resolution input imaging data. In some cases, the neural network storage 108 is stored on a memory accessible locally or remotely (e.g., accessible via a network such as a local area network, a wide area network, a cloud network, or the Internet).

A pre-trained neural network can be selected based on user input, such as via the user selecting an individual pre-trained neural network from a list of available neural networks, or via the user providing information about the sample to be scanned or combination of imaging modalities used, which information can be used to suggest and/or identify one or more pre-trained neural networks suitable for the sample. For example, a sample sharing the same or similar category information as that used to pre-train a neural network (whether via federated learning or not) may be able to use that pre-trained neural network with success. Category information can be information usable to identify a category to which a sample belongs. Any suitable types of categories can be used, such as “minerals,” “calcium-rich samples,” “skin tissue,” and the like.

In some cases, a neural network trained using a processing module 104 can be stored in the neural network storage 108, optionally with additional information associated with the sample and/or the scan. Additional information associated with the sample can include identification information (e.g., a unique identifier or a description), category information (e.g., an indication as to the category to which the sample belongs), imaging data or a reconstructed volume of the sample generated using the neural network, imaging data or a reconstructed volume of a standardized set of imaging data (e.g., of a generic standardized sample or a specific standardized sample selected to be similar to the sample, such as having the same category). Additional information associated with the scan can include information associated with any used imaging modalities, such as type of major imaging modality, type of minor imaging modality, imager identification information (e.g., a model number of the X-ray imager, a model number or type of the X-ray source(s) and/or detector(s), and the like), scan recipe information (e.g., information about one or more parameters used in the scanning or imaging of the sample), and the like. Any information stored in the neural network storage 108 in association with a pre-trained neural network can be used to help select a pre-trained neural network to use when processing imaging data from a new sample.

An input/output module 106 can be coupled to the processing module 104 to receive user input and/or provide output to a user. Any suitable input/output devices can be implemented in the input/output module 106, such as a keyboard, a mouse, a display (e.g., computer monitor), a touchscreen, light emitting diodes (LEDs) or other light sources, buttons, and the like. The processing module 104 can present input imaging data, generated output imaging data (e.g., image-quality-improved imaging data), reconstructed volumes, and the like via the input/output module 106. In some cases, the input/output module 106 can act to store imaging data, a reconstructed volume, and/or a trained neural network (e.g., on a local memory, removable memory, or network-accessible memory). In some cases, a neural network trained using a processing module 104 can be stored in association with the generated output imaging data or reconstructed volume.

In some cases, any of the first imaging data source 102, the second imaging data source 103, the processing module 104, the input/output module 106, and the neural network storage 108 can be incorporated into one or more housings in any suitable combination. Any combination of one or more of the first imaging data source 102, the second imaging data source 103, the processing module 104, the input/output module 106, and the neural network storage 108 can be implemented locally (e.g., on the same device as one another or on devices coupled by a bus or local area network) or remotely (e.g., via a wide area network, the Internet, or a cloud network). In an example, a processing module 104 can be implemented on a user's laptop computer, the first imaging data source 102 and/or second imaging data source 103 can be implemented on a cloud-based health record database (e.g., one or more servers accessible via the Internet), and the neural network storage 108 can be implemented on a separate cloud-based analysis database (e.g., one or more servers accessible via the Internet). In some cases, no neural network storage 108 is used.

In another example, the processing module 104 can be incorporated into the first imaging data source 102 and/or second imaging data source 103, such as a computer for processing imaging data that is also used to control an X-ray microscope or other imager. In another example, the processing module 104 can be incorporated into an individual computer that accesses, via a network-accessible database, imaging data supplied from a separate CT scanner or X-ray microscope.

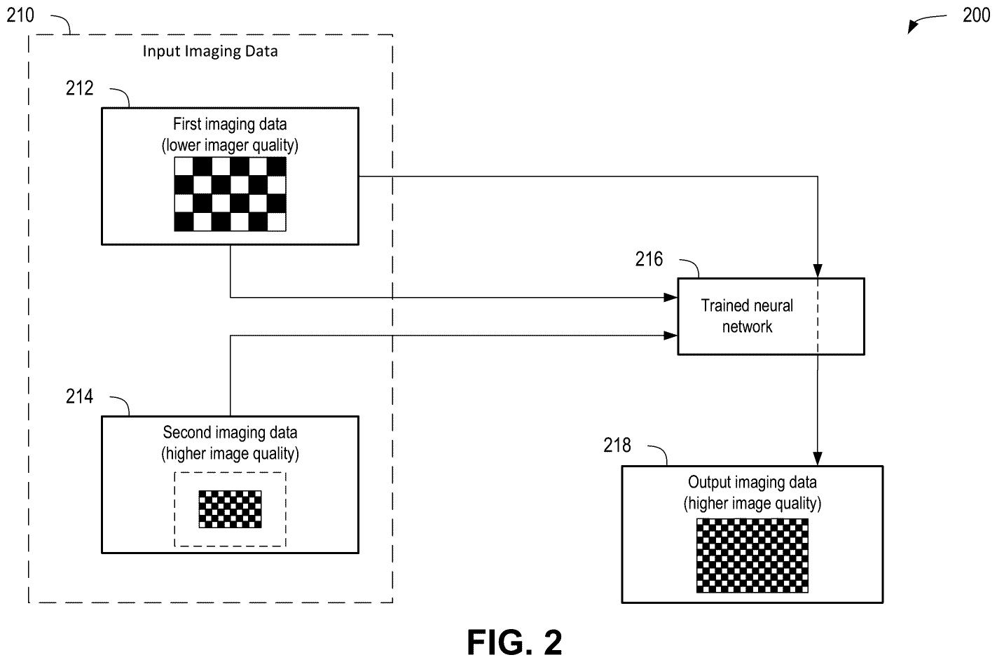

FIG. 2 is a schematic diagram 200 depicting input imaging data 210 being used to train a neural network and obtain high-image-quality output imaging data 218, according to certain aspects of the present disclosure. The elements of diagram 200 can be implemented using imaging data processing system 100 of FIG. 1.

Input imaging data 210 can contain both first imaging data 212 and second imaging data 214. First imaging data 212 can have lower image quality (e.g., a lower resolution) and larger field-of-view than the second imaging data 214. As used with reference to first imaging data 212 and second imaging data 214, the terms “first” and “second” do not necessarily indicate that one is acquired before the other, rather that one is acquired in a different fashion than the other (e.g., using different imaging modalities, equipment, and/or settings to achieve a different field of view and/or different image quality). The second imaging data 214 can overlap a portion of the first imaging data 212, such that the first imaging data 212 and second imaging data 214 can be registered to or aligned with one another.

The first imaging data 212 (e.g., a portion of the first imaging data 212 that overlaps with the second imaging data 214) and the second imaging data 214 can be used to train a neural network 216. Training, which can occur as disclosed herein in further detail, can allow the trained neural network 216 to take lower-image-quality imaging data (e.g., first imaging data 212) as input and generate output data that has an image quality similar to the higher-image-quality imaging data (e.g., second imaging data 214). Thus, features in the lower-image-quality imaging data that are associated with certain structures found in the higher-image-quality imaging data can be recovered by the trained neural network to output improved-image-quality imaging data from the lower-image-quality imaging data.

Once the trained neural network 216 has been established (e.g., trained), the same first imaging data 212 (e.g., the full first imaging data 212 or at least more than the portion of the first imaging data 212 used to train the neural network) can be used as input to the trained neural network 216 to generate output imaging data 218. The output imaging data 218 can have the same field-of-view as the first imaging data 212, but because of the processing within the trained neural network 216, the output imaging data 218 can have improved image quality with respect to the first imaging data 212 (e.g., a higher resolution than that of the first imaging data 212, such as a resolution that is the same or similar to the second imaging data 214). The output imaging data 218 can thus be considered higher-image-quality imaging data (e.g., super-resolution imaging data in the context of improved resolution).

Thus, a higher-image-quality (e.g., as compared to the image quality of the first imaging data 212) set of output imaging data 218 can be generated for a given lower-imaging-quality set of first imaging data 212 by training a neural network (e.g., trained neural network 216) using the first imaging data 212 and higher-image-quality second imaging data 214 that is associated with (e.g. at least partially overlapping and of the same sample as) the first imaging data 212.

For illustrative purposes, first imaging data 212 is depicted with a large rectangle with dots sparsely filled therein, representative of the relatively lower image quality and relatively larger FOV. By contrast, second imaging data 214 is depicted with a smaller rectangle filled with dense squares, representative of the relatively higher image quality and relatively smaller FOV. The larger dashed rectangle surrounding that smaller rectangle is representative of the FOV of the first imaging data 212, thus indicating that at least a portion of the second imaging data 214 is located within (e.g., overlaps) at least a portion of the FOV of the first imaging data 212. The output imaging data 218 is depicted with a large rectangle that is the same size as that of the first imaging data 212, and thus the same FOV as the first imaging data 212, but with the dense squares of the second imaging data 214, and thus the same or approximately the same image quality as the second imaging data 214.

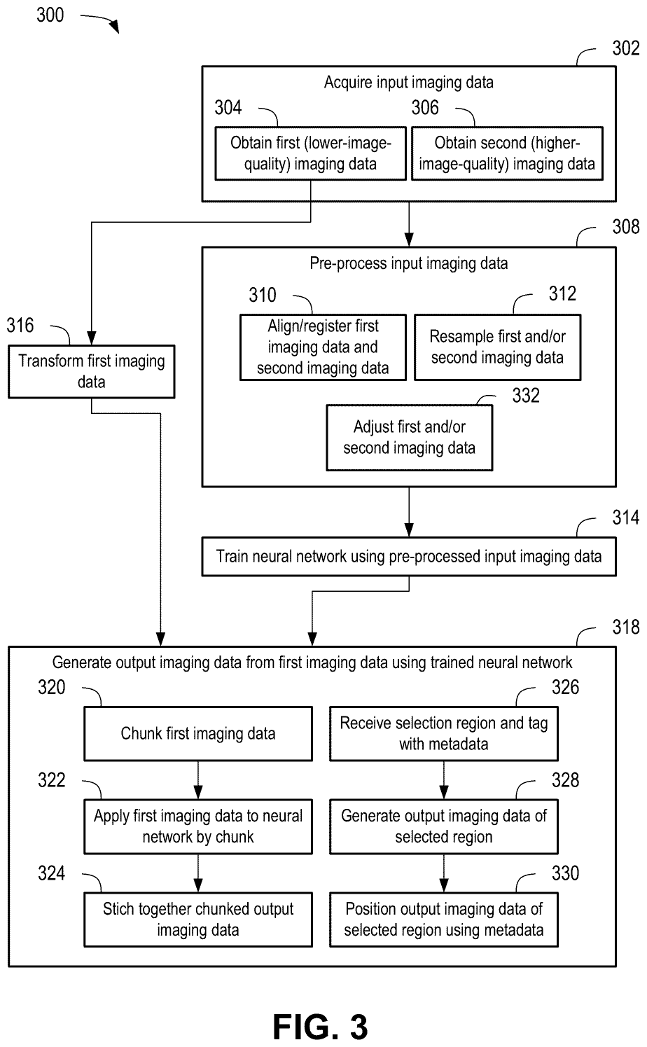

FIG. 3 is a flowchart depicting a process 300 for processing imaging data, according to certain aspects of the present disclosure. Process 300 can operate on any suitable imaging data processing system, such as imaging data processing system 100 of FIG. 1

At block 302, input imaging data is acquired. Input imaging data can be acquired of a single sample (e.g., a single object or target). In some cases, all input imaging data can be acquired while the sample(s) are held fixed with respect to a sample holder, regardless of movement of the sample holder within and/or between one or more instruments. The input imaging data can be acquired using a single imager (e.g., a CT scanner), although that need not always be the case, such as when multiple major imaging modalities are used. In some cases, acquiring input imaging data can include receiving input imaging data from storage or memory. In some cases, acquiring input imaging data can include using an imager to acquire the imaging data, such as by performing one or more scans of a sample.

Acquiring input imaging data at block 302 can include obtaining first imaging data at block 304 and obtaining second imaging data at block 306. Obtaining first imaging data at block 304 and obtaining second imaging data at block 306 can be performed using different imaging modalities, such as different major imaging modalities (e.g., different types of imager, such as an X-ray imager and an electron microscope) or different minor imaging modalities (e.g., different subtypes of the same type of imager, such as a low-resolution large-FOV X-ray imager and a high-resolution small-FOV X-ray imager). Obtaining first imaging data at block 304 and obtaining second imaging data at block 306 can include using the same imager or different imagers. Obtaining first imaging data at block 304 can be performed before obtaining second imaging data at block 306, such as in cases where the first imaging data is used to determine the portion of the sample to be imaged in the second imaging data or when the second imaging technique is destructive, although that need not always be the case. Obtaining first imaging data at block 304 can include obtaining low-image-quality (e.g., lower image quality than the second imaging data) imaging data with a large FOV (e.g., a larger FOV than the second imaging data). Obtaining second imaging data at block 306 can include obtaining high-image-quality (e.g., higher image quality than the first imaging data) imaging data with a small FOV (e.g., a smaller FOV than the first imaging data). The second imaging data obtained at block 306 can at least partially overlap at least a portion of the first imaging data obtained at block 304.

At block 308, the input imaging data can be pre-processed. Pre-processing at block 308 can include preparing the input imaging data for use to train a neural network. In some cases, pre-processing at block 308 can include preprocessing respective regions of the first imaging data and the second imaging data that overlap. In some cases, the overlapping regions include a portion of the first imaging data and all of the second imaging data, although that need not always be the case.

In some cases, pre-processing at block 308 can include aligning and/or registering first imaging data (e.g., all of the first imaging data and/or the overlapping portions) and second imaging data at block 310. Aligning and/or registering first imaging data and second imaging data at block 310 can include aligning the first and second imaging data in any suitable fashion, such as using relative sample holder coordinates (e.g., XYZ stage positions with respect to the sample stage) of the two tomographies or using other known registration points. In some cases, aligning and/or registering first imaging data and second imaging data can include performing a 3, 6, or 9 degree of freedom sub-pixel alignment on the first imaging data and/or the second imaging data. In some cases, aligning and/or registering first imaging data and second imaging data can include applying a machine learning model trained for registration to one or both of the first imaging data and the second imaging data to output registration information and/or aligned imaging data. Such a machine learning model can be trained using unsupervised techniques using training imaging data acquired using the imaging modalities used to acquire the first imaging data at block 304 and acquire the second imaging data at block 306. In some cases, aligning and/or registering the first imaging data and the second imaging data can include determining the imaging modalities associated with the input imaging data and selecting an appropriate machine learning model for aligning and/or registering those imaging modalities (e.g., when first imaging data is acquired using an X-ray imager and second imaging data is acquired using a transmission electron microscope, a specific machine learning model that has been trained on training imaging data from X-ray imagers and transmission electron microscopes can be selected for use). Aligning and/or registering the first imaging data and the second imaging data at block 310 can result in the first and second imaging data being spatially aligned.

In some cases, pre-processing at block 308 can include resampling, at block 312, the first imaging data and/or the second imaging data. Resampling first imaging data can include resampling the first imaging data onto the grid of the second imaging data, such as via interpolation or other suitable resampling techniques. In some cases, resampling data can include resampling the first imaging data and/or the second imaging data onto a common grid (e.g., to a common target resolution). In some cases, resampling data at block 312 can include resampling (e.g., down-sampling) the second imaging data to a target resolution that is the resolution of the first imaging data or is a resolution between that of the first imaging data and that of the second imaging data. In some cases, resampling at block 312 can be performed on the spatially aligned first and second imaging data, although that need not always be the case.

In some cases, pre-processing at block 308 can further include adjusting the first imaging data and/or the second imaging data at block 332. Adjusting the first imaging data and/or the second imaging data can include applying one or more adjustments to the first imaging data, the second imaging data, or the first imaging data and the second imaging data. These adjustments can be preset, manually selected, or automatically selected based on the imaging modalities associated with the first imaging data and the second imaging data. The adjustments can be designed to cause the first imaging data and/or the second imaging data to normalize common differences between the two imaging modalities. Such adjustments can be based solely on the imaging modalities in use, or can further be based on sample information, such as category information of the sample. In some cases, applying the adjustments at block 308 can include applying one or more adjustments to the second imaging data to have the second imaging data appear closer to how generic imaging data acquired using the imaging modality associated with the first imaging data would appear. For example, if the first imaging data is acquired using an X-ray imager and the second imaging data is acquired using a transmission electron microscope, the second imaging data can be adjusted in color content, contrast, and/or other image features such that the second imaging data appears as if it were imaging data from an X-ray imager.

In some cases, pre-processing at block 308 can include outputting the first and second imaging data (e.g., after spatial alignment, registration, resampling, and/or application of adjustments) in a fashion suitable for training the neural network. In some cases, pre-processing at block 308 can include outputting two correlated arrays (e.g., one for the first imaging data and one for the second imaging data) as input-target pairs in a format amenable to the neural network. The neural network can then leverage the input-target pairs during training such that the neural network is trained to generate the target (or an output similar to the target) from the input.

In some cases, pre-processing at block 308 can include outputting only the overlapping portions of the first imaging data and the second imaging data. In other words, if the second imaging data fits entirely within the FOV of the first imaging data, the pre-processing at block 308 may crop the first imaging data such that the first imaging data supplied to the neural network for training is the same size as the second imaging data supplied to the neural network for training.

At block 314, the neural network is trained using the pre-processed input imaging data. In some cases, training the neural network can include accessing an initial or pre-trained neural network and further training such a neural network based on the pre-processed input imaging data. In some cases, training the neural network can include training a CNN, or more specifically, a u-net, or more specifically a u-net modified to work with 2D and 2.5D imaging data.

Training the neural network at block 314 can include supplying pre-processed first imaging data to the neural network to generate an output. The output can be compared to the pre-processed second imaging data. The operating parameters of the neural network can then be adjusted to minimize the differences between the output and the pre-processed second imaging data. This process can occur iteratively until the neural network is sufficiently trained to achieve the desired output. Training the neural network at block 314 can include training the neural network to map low-image-quality (e.g., low-resolution) imaging data (e.g., the pre-processed first imaging data) to high-image-quality (e.g., high-resolution) imaging data (e.g., the pre-processed second imaging data). The resultant model (e.g., trained neural network) can optimize creation of features as they are exhibited at high image quality based on the input as exhibited at low image quality. The result of block 314 is a neural network (e.g., model) that has been trained using low-image-quality and high-image-quality imaging data of an overlapping region (e.g., overlapping area and/or volume) of the same sample.

At block 318, output imaging data can be generated from the first imaging data (e.g., the first imaging data obtained at block 304) and the trained neural network. In some cases, the first imaging data can be pre-processed, such as similar to pre-processing at block 308, although that need not always be the case. In some cases, generating the output imaging data at block 318 can further make use of the second imaging data (e.g., the second imaging data obtained at block 306), although that need not always be the case.

In some cases, the first imaging data can be optionally transformed at block 316 prior to being applied to the trained neural network at block 318. Transforming the first imaging data at block 316 can include applying a zoom transformation to the original first imaging data so that the imaging data is interpolated such that the new pixel grid has an effective pixel size equal to the high-image-quality (e.g., high-resolution) dataset (e.g., the second imaging data).

Generating the output imaging data at block 318 can include generating the output imaging data in chunks. In such cases, the first imaging data can be split into chunks at block 320. In some cases, the first imaging data is split such that at least a portion of each chunk overlaps at least a portion of an adjacent chunk. Each of the individual chunks can then be applied to the neural network at block 322 to generate a corresponding output chunk. Each of the output chunks can then be stitched together at block 324. The overlapping regions of the chunks as split at block 320 can facilitate stitching together of corresponding output chunks at block 324. In some cases, chunking can especially be helpful to permit the process 300 to be performed on hardware that may not otherwise have sufficient computational strength to handle larger amounts of input data.

In some cases, a portion of less than all of the first imaging data can be processed for super-resolution. In such cases, generating the output imaging data at block 318 can include receiving a selection identifying a selection region at block 326. The selection can indicate the selection region that is to be processed for super-resolution. The selection region can be tagged, at block 326, with metadata indicative of a location of the selection region. At block 328, output imaging data can be generated based on the selected region (e.g., the first imaging data associated with the selected region). The output imaging data can then be positioned using the metadata from block 326. In some cases, positioning the output imaging data can include tagging the output imaging data with the metadata from block 326. Thus, the metadata associated with the selection region is automatically used to tag the resultant output imaging data based on that selection region. That metadata can then be used to position the output imaging data, such as within a two-dimensional image or three-dimensional volume.

In some cases, generating the output imaging data at block 318 can further include presenting the output imaging data, such as in the form of a two-dimensional image or three-dimensional volume.

In some cases, some or all of the blocks of process 300 (e.g., blocks 308, 314, 318) can be repeated multiple times for a single sample. In some cases, a determination can be made as to the variance and/or homogeneity within the sample, which can be used to identify multiple variance regions within the sample. For example, identified transitions within a sample can be used to split the sample into multiple variance regions. Determining variance regions can be automatic (e.g., by analysis of the first imaging data and/or second imaging data) or manual (e.g., by user input). When performed automatically, the determined variance regions can be presented to the user for approval and/or modification, although that need not always be the case. Determination of variance and/or homogeneity can be performed at any suitable stage, such as during acquisition of input imaging data at block 302, after pre-processing of input imaging data at block 308, or at other suitable times. Determining the variance and/or homogeneity can include identifying a plurality of variance regions to be processed separately. Each variance region can define one or more closed areas or volumes associated with a portion of the input imaging data sharing similar features. In some cases, variance regions can be defined to include at least some overlap with adjacent variance regions to facilitate subsequent stitching together of output imaging data. A neural network can be trained for each of the variance regions using imaging data (e.g., first imaging data and second imaging data) associated with that particular homogeneity region. Then, for each of the homogeneity regions, output imaging data can be generated. This output imaging data for each of the homogeneity regions can be stitched together, in some cases leveraging any available overlap between adjacent homogeneity regions.

In an example, a sample containing a flat, cog-shaped object of a first material positioned within and at the center of a cube-shaped second material may be segregated into three variance regions: i) a first circular variance region for the first material within the cog-shaped object; ii) a second annular-shaped variance region for the interface region between the first material and second material, and iii) a third variance region for the remainder of the sample, which is made of the second material. Thus, the neural network trained for the first variance region can be specifically trained to improve image quality in the regions of the sample made of the first material, the neural network trained for the third variance region can be specifically trained to improve image quality in the regions of the sample made of the second material, and the neural network trained for the second variance region can be specifically trained to improve image quality in regions that include interfaces between the first material and the second material and/or regions that include cog-shaped projections (e.g., an increased number of edges).

In some cases, at least one of the variance regions can be excluded from creation of a new neural network, in which case an existing neural network (e.g., a sample-category-specific neural network without additional sample-specific training) can be leveraged to improve image quality of the imaging data associated with that variance region, or the imaging data associated with that variance region can be used without image quality improvement.

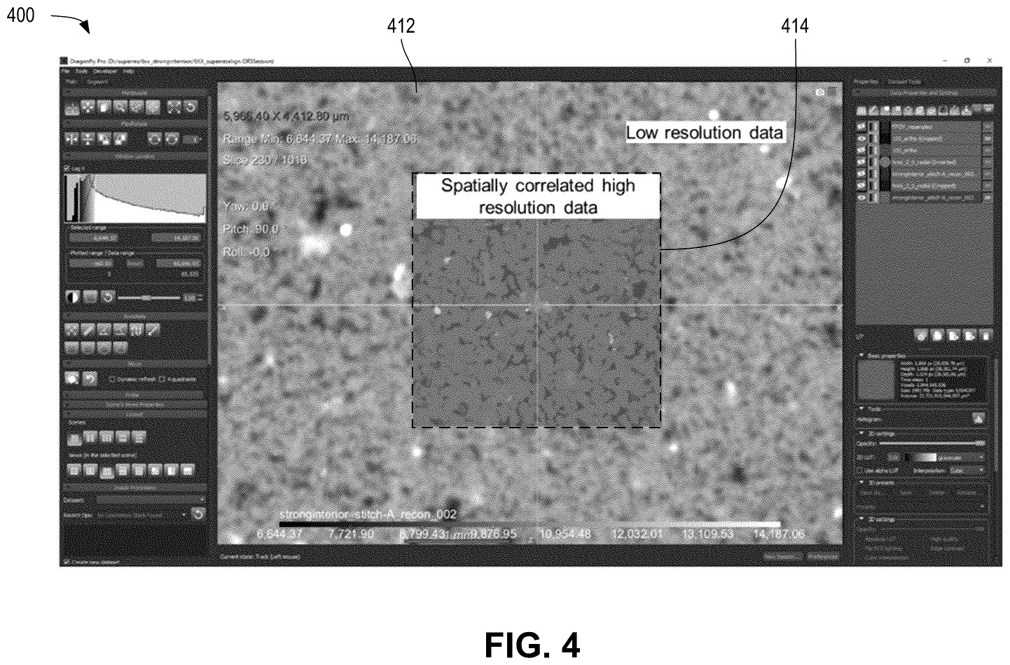

FIG. 4 is a schematic diagram of a graphical user interface (GUI) 400 depicting first and second imaging data, according to certain aspects of the present disclosure. The GUI 400 can be a result of an image acquisition program designed to acquire both first imaging data 412 and second imaging data 414. The GUI 400 can operate on any suitable imaging data processing system, such as imaging data processing system 100 of FIG. 1

The GUI 400 can include various controls and options for acquiring imaging data, saving imaging data, and/or modifying imaging data. As depicted, GUI 400 is showing first imaging data 412 and second imaging data 414. The first imaging data 412 is relatively low-resolution imaging data (e.g., the lower-image-quality imaging data). While certain structures and features are somewhat visible in the first imaging data 412, there may be a desire for higher resolution imaging of such structures. In some cases, second imaging data 414 can be acquired for certain regions within the FOV of the first imaging data 412. Generally, the second imaging data 414 can be acquired specifically for regions within the FOV of the first imaging data 412 that contain structures of interest, although that need not always be the case. In some cases, the boundaries used to acquire the second imaging data 414 can be defined to maximize neural network training efficiency, such as by selecting a region of the FOV of the first imaging data 412 that appears to have the widest variety of different structures and/or features of interest (e.g., not necessarily the largest number of structures and/or feature of interest).

In some cases, the GUI 400 can provide tools to facilitate registering and/or aligning the first imaging data 412 and second imaging data 414.

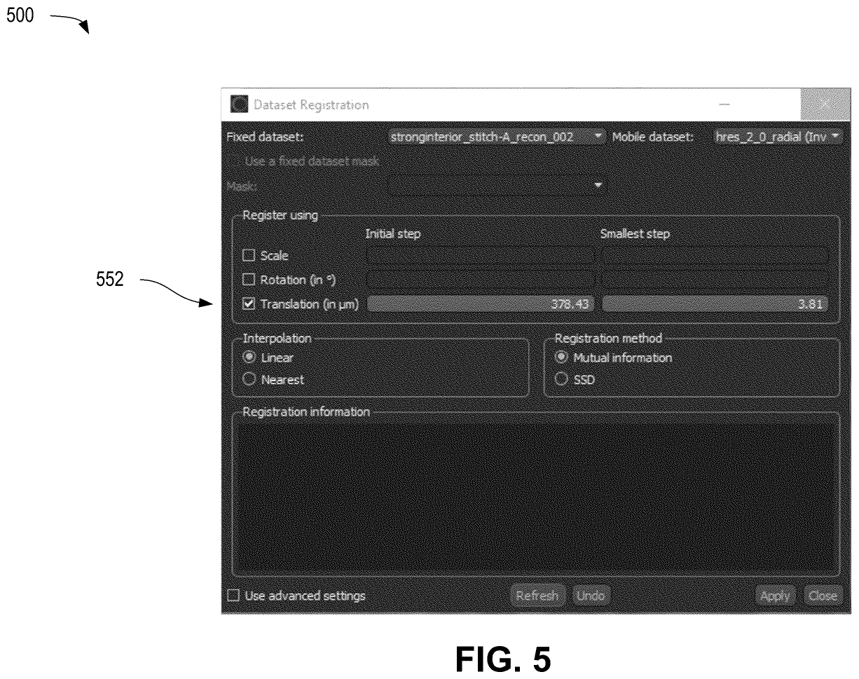

FIG. 5 is a schematic diagram of a graphical user interface (GUI) 500 for aligning first and second imaging data, according to certain aspects of the present disclosure. The GUI 500 can operate on any suitable imaging data processing system, such as imaging data processing system 100 of FIG. 1. In some cases, GUI 500 can be GUI 400 of FIG. 4 after selection of a dataset registration tool.

The dataset registration tool depicted in GUI 500 can allow a user to register and/or align first imaging data and second imaging data. Various registration and/or alignment techniques can be used, depending on the registration options 552 selected. As depicted in FIG. 5, the registration options 552 selected by the user indicate registration is to be performed using translation (e.g., with an initial step of 378.43 micrometers and a smallest step of 3.81 micrometers), linear interpolation, and mutual information based registration (instead of sum of squared differences based registration). Other registration/alignment techniques can be used.

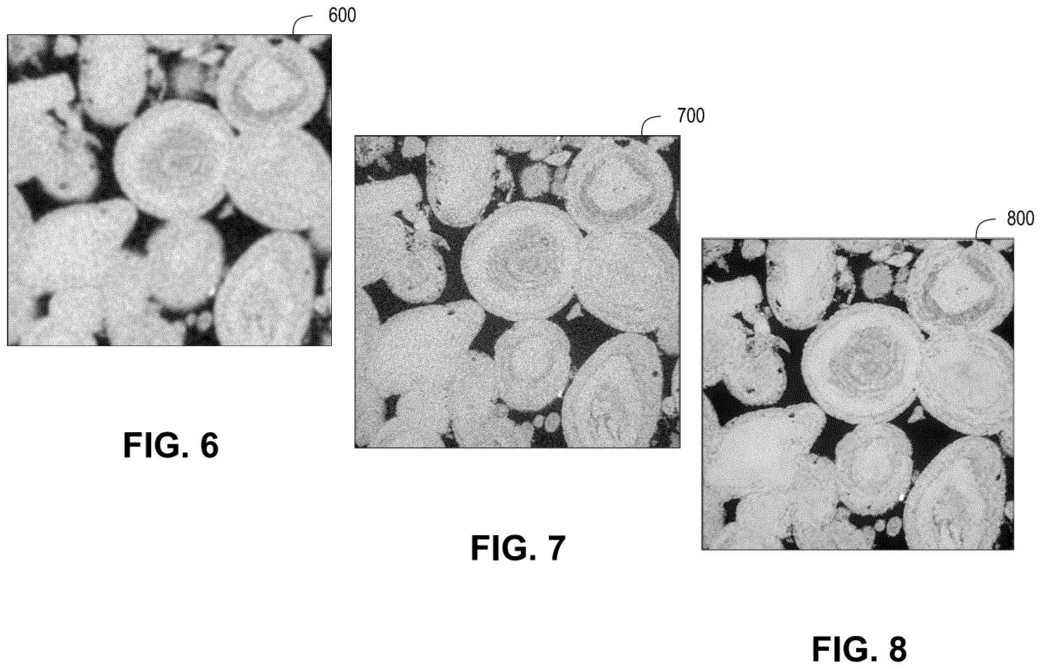

FIG. 6 is a portion of a low-resolution image 600, according to certain aspects of the present disclosure. Low-resolution image 600 can be a two-dimensional image created from first imaging data (e.g., low-image-quality imaging data). The low-resolution image 600 can show features of the objected being imaged, but without the same clarity provided by a higher-resolution image. The low-resolution image 600 can have an input pixel size of approximately 10 micrometers.

FIG. 7 is a portion of a high-resolution image 700, according to certain aspects of the present disclosure. High-resolution image 700 can be second imaging data (e.g., high-image-quality imaging data) acquired of the same region of the same object as low-resolution image 600 of FIG. 6. The high-resolution image 700 can show more details than the low-resolution image 600 of FIG. 6, but potentially with greater noise or other artefacts. The high-resolution image 700 can have a pixel size of approximately 2.5 micrometers.

FIG. 8 is a portion of an improved-image-quality (e.g., super-resolution) image 800, according to certain aspects of the present disclosure. Improved-image-quality image 800 can be generated by passing the low-resolution image 600 of FIG. 6 through a neural network that has been trained, as disclosed herein, using the low-resolution image 600 of FIG. 6 and the high-resolution image 700 of FIG. 7. The improved-image-quality image 800 can have the same field of view as the low-resolution image 600, but with improved resolution (e.g., resolution the same as or similar to that of the high-resolution image 700 of FIG. 7). In some cases, the improved-image-quality image 800 can further demonstrate reduced artefacts, such as reduced noise, as compared to the low-resolution image 600 of FIG. 6 and/or the high-resolution image 700 of FIG. 7. The improved-image-quality image 800 can achieve an effective pixel size at or near that of the high-resolution image 700 of FIG. 7, such as at or approximately 2.5 micrometers.

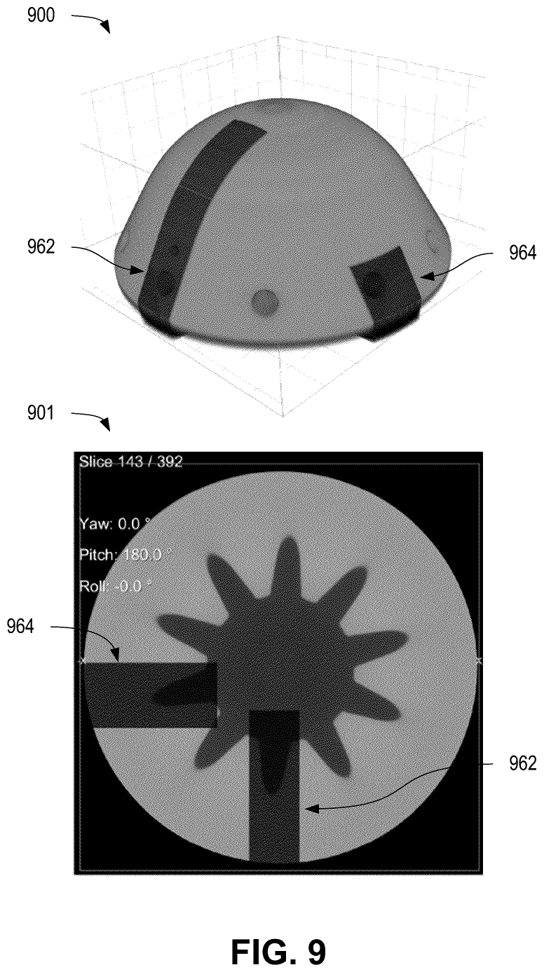

FIG. 9 is a combination image depicting a three-dimensional volume 900 and corresponding two-dimensional image 901 from below for selecting regions for image quality improvement processing, according to certain aspects of the present disclosure. The three-dimensional volume 900 and corresponding two-dimensional image 901 can be based on first imaging data (e.g., first imaging data 212 of FIG. 2). The selection process depicted in FIG. 9 can occur using any suitable system, such as imaging data processing system 100 of FIG. 1.

Region 962 and region 964 can be selected for image quality improvement processing. Selection of regions 962, 964 can occur using any suitable technique, such as using graphical (e.g., mouse and cursor) and/or text-based (e.g., via keyboard) techniques. Each region 962, 964 can be indicative of corresponding regions of the first imaging data, which can be labeled with metadata indicative of where such corresponding regions are located in the three-dimensional volume 900 and/or corresponding two-dimensional image 901. After selection of any desired regions (e.g., regions 962, 964), the user can instruct the system to begin image quality improvement processing accordingly.

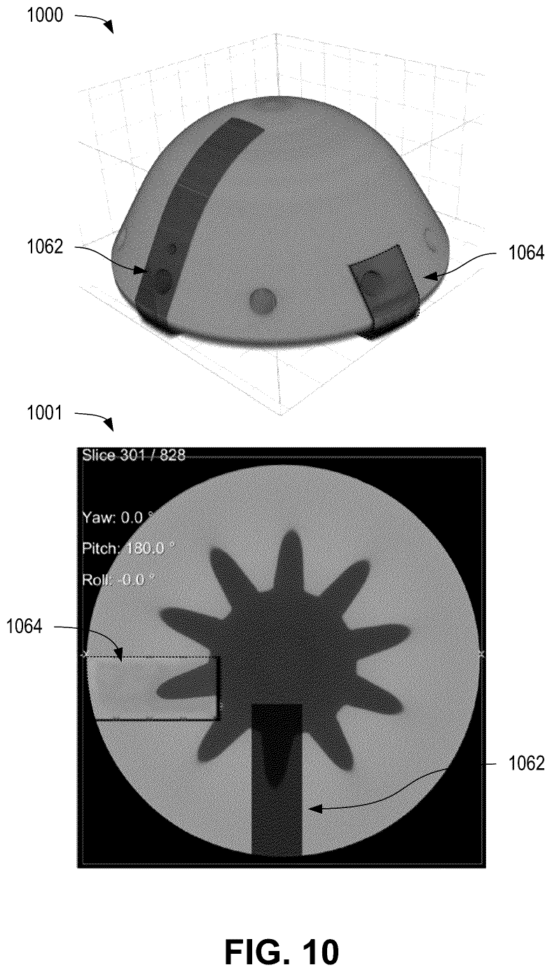

FIG. 10 is a combination image depicting a three-dimensional volume 1000 and corresponding two-dimensional image 1001 from below containing a region of improved-image-quality imaging data, according to certain aspects of the present disclosure. The three-dimensional volume 1000 and corresponding two-dimensional image 1001 can be based on a combination of first imaging data (e.g., first imaging data 212 of FIG. 2) and improved-image-quality imaging data (e.g., output imaging data 218 of FIG. 2). The combination image depicted in FIG. 10 can be generated and/or presented using any suitable system, such as imaging data processing system 100 of FIG. 1.

The combination image of FIG. 10 can be based on the combination image of FIG. 9 after image quality improvement processing of region 964 of FIG. 9. In FIG. 10, region 1062 is selected for future image quality improvement processing, however region 1064 has already been processed, such that region 1064 is based on improved-image-quality imaging data. Thus, three-dimensional volume 1000 can be based primarily on first imaging data (e.g., low-resolution imaging data), except for at least region 1064, which has been replaced with improved-image-quality imaging data, and is thus depicted with an improved image quality (e.g., higher resolution) than that of other portions of the three-dimensional volume 1000. Likewise, two-dimensional image 1001 can be based primarily on first imaging data (e.g., low-resolution imaging data), except for at least region 1064, which has been replaced with improved-image-quality imaging data, and is thus depicted with an improved image quality (e.g., higher resolution) than that of other portions of the two-dimensional image 1001.

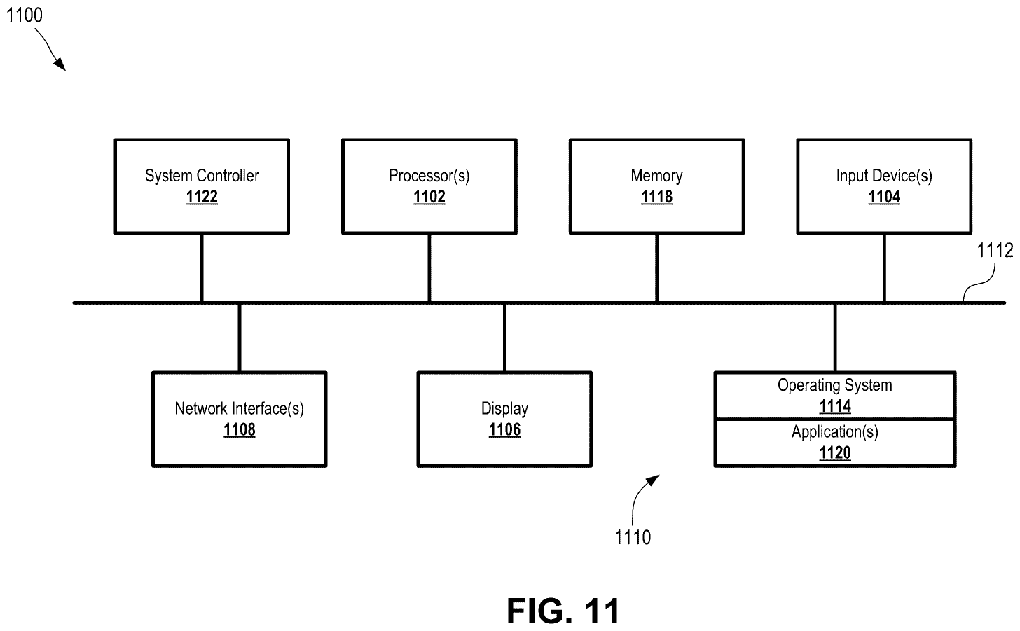

FIG. 11 is a block diagram of an example system architecture 1100 for implementing features and processes of the present disclosure, such as those presented with reference to FIGS. 1-10. The architecture 1100 can be used to implement any suitable computing device (e.g., a server, workstation, tablet, cloud, or other such devices or services) for practicing the various features and processes of the present disclosure. The architecture 1100 can be implemented on any electronic device that runs software applications derived from compiled instructions, including without limitation personal computers, servers, smart phones, electronic tablets, game consoles, email devices, imagers (e.g., imaging machines, such as X-ray microscopes and CT scanners) and the like. In some implementations, the architecture 1100 can include one or more processors 1102, one or more input devices 1104, one or more display devices 1106, one or more network interfaces 1108, and one or more computer-readable mediums 1110. Each of these components can be coupled by bus 1112.

In some cases, system architecture 1100 can be incorporated into a computing system capable of performing X-ray scans, such as a computing system used to control an X-ray imager or CT scanner. In some cases, system architecture 1100 can be incorporated into a workstation computer used primarily for viewing and interpreting imaging data from an X-ray scan. In some cases, system architecture 1100 can be incorporated into a computer system used to train neural networks, such as a computer system optimized for the training of deep neural networks.

In some implementations, system architecture 1100 can correspond to a single server in a rack of servers. Various rack configurations can be implemented. For example, a rack can include multiple chassis and each chassis can contain multiple servers. Each server in the rack can be connected by various hardware components (e.g., backbone, middle plane, etc.).

Display device 1106 can be any known display technology, including but not limited to display devices using Liquid Crystal Display (LCD) or Light Emitting Diode (LED) technology. Processor(s) 1102 can use any known processor technology, including but not limited to graphics processors and multi-core processors. Input device 1104 can be any known input device technology, including but not limited to a keyboard (including a virtual keyboard), mouse, track ball, and touch-sensitive pad or display. Bus 1112 can be any known internal or external bus technology, including but not limited to ISA, EISA, PCI, PCI Express, NuBus, USB, Serial ATA or FireWire.

Computer-readable medium 1110 can be any medium that participates in providing instructions to processor(s) 1102 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Processor(s) 1102 can include any combination of suitable processors. Certain aspects of the present disclosure can be especially useful when implemented using one or more graphic processing units (GPUs), field-programmable gate arrays (FPGAs), and/or tensor processing units (TPUs) or other artificial intelligence accelerators. In some cases, certain instructions for executing code on GPUs, FPGAs, and/or TPUs can be programmed using an appropriate language (e.g., Compute Unified Device Architecture (CUDA) for certain GPUs, or a hardware description language for FPGAs).

Computer-readable medium 1110 can include various instructions for implementing operating system 1114 and applications 1120 such as computer programs. The operating system can be multi-user, multiprocessing, multitasking, multithreading, real-time and the like. The operating system 1114 performs basic tasks, including but not limited to: recognizing input from input device 1104; sending output to display device 1106; keeping track of files and directories on computer-readable medium 1110; controlling peripheral devices (e.g., disk drives, printers, X-ray microscopes, etc.) which can be controlled directly or through an I/O controller; and managing traffic on bus 1112. Computer-readable medium 1110 can include various instructions for implementing firmware processes, such as a BIOS. Computer-readable medium 1110 can include various instructions for implementing any of processes described herein, including at least process 300 of FIG. 3.

Memory 1118 can include high-speed random access memory and/or non-volatile memory, such as one or more magnetic disk storage devices, one or more optical storage devices, and/or flash memory (e.g., NAND, NOR). The memory 1118 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 1118 can store an operating system, such as Darwin, RTXC, LINUX, UNIX, OS X, WINDOWS, or an embedded operating system such as VxWorks.

System controller 1122 can be a service processor that operates independently of processor 1102. In some implementations, system controller 1122 can be a baseboard management controller (BMC). For example, a BMC is a specialized service processor that monitors the physical state of a computer, network server, or other hardware device using sensors and communicating with the system administrator through an independent connection. The BMC is configured on the motherboard or main circuit board of the device to be monitored. The sensors of a BMC can measure internal physical variables such as temperature, humidity, power-supply voltage, fan speeds, communications parameters and operating system (OS) functions.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java, CUDA), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computing system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an application programming interface (API). An API can define one or more parameters that are passed between a calling application and other software code (e.g., an operating system, library routine, function) that provides a service, that provides data, or that performs an operation or a computation. In an example, an API can be used to facilitate accessing and/or storing neural networks.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, and the like.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art. Numerous changes to the disclosed embodiments can be made in accordance with the disclosure herein, without departing from the spirit or scope of the disclosure. Thus, the breadth and scope of the present disclosure should not be limited by any of the above described embodiments.

Although certain aspects and features of the present disclosure have been illustrated and described with respect to one or more implementations, equivalent alterations and modifications will occur or be known to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only, and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

As used below, any reference to a series of examples is to be understood as a reference to each of those examples disjunctively (e.g., “Examples 1-4” is to be understood as “Examples 1, 2, 3, or 4”).
Example 1 is a system, comprising: one or more data processors; and a non-transitory computer-readable storage medium containing instructions which, when executed on the one or more data processors, cause the one or more data processors to perform operations including: receiving first imaging data associated with a sample, the first imaging data acquired using a first imaging modality; receiving second imaging data associated with the sample, the second imaging data acquired using a second imaging modality that is different than the first imaging modality; aligning the first imaging data and the second imaging data; identifying a portion of the first imaging data overlapping with the second imaging data; training a neural network based at least in part on the portion of the first imaging data and the second imaging data; and generating output imaging data by applying the trained neural network to the first imaging data or a third imaging data that is acquired using the first imaging modality.
Example 2 is the system of example(s) 1, wherein the first imaging data is associated with a first image quality, wherein the second imaging data is associated with a second image quality, and wherein the output imaging data is associated with a third image quality that is improved with respect to the first image quality.
Example 3 is the system of example(s) 2, wherein the first image quality is associated with a first objective measurement, wherein the second image quality is associated with a second objective measurement, and wherein the third image quality is associated with a third objective measurement that is i) between the first objective measurement and the second objective measurement, or ii) the same as the second objective measurement.
Example 4 is the system of example(s) 1-3, wherein the first imaging data is acquired at a first resolution and first field of view, wherein the second imaging data is acquired at a second resolution that is higher than the first resolution and a second field of view that is smaller than the first field of view, and wherein the output imaging data has a higher resolution than the first resolution.
Example 5 is the system of example(s) 1-4, wherein the first imaging modality and the second imaging modality share a common major imaging modality.
Example 6 is the system of example(s) 1-4, wherein the first imaging modality includes a first major imaging modality that is X-ray microscopy, and wherein the second imaging modality includes a second major imaging modality that is not X-ray microscopy.
Example 7 is the system of example(s) 1-6, wherein aligning the first imaging data and the second imaging data includes automatically applying a 3, 6, or 9 degree of freedom sub-pixel alignment to at least one of the first imaging data and the second imaging data to align the first imaging data and the second imaging data.
Example 8 is the system of example(s) 1-7, wherein the operations further comprise resampling at least a portion of the first imaging data onto a grid of the second imaging data.
Example 9 is the system of example(s) 1-8, wherein training the neural network includes: providing the portion of the first imaging data associated with the second imaging data to the neural network to generate the output data; and adjusting the neural network to reduce a difference between the generated output data and the second imaging data.
Example 10 is the system of example(s) 1-9, wherein generating the output imaging data includes: applying a zoom transform to the first imaging data to achieve an effective pixel size equal to the pixel size of the second imaging data; applying the transformed first imaging data to the trained neural network to generate the output imaging data.
Example 11 is the system of example(s) 1-10, wherein generating the output imaging data includes: segmenting the first imaging data into a plurality of chunks, wherein each chunk includes at least one overlapping region with an adjacent chunk; applying each of the plurality of chunks of the first imaging data to the trained neural network to generate a corresponding chunk of the output imaging data; and stitching together the overlapping regions of the corresponding chunks of the output imaging data.
Example 12 is the system of example(s) 1-11, wherein generating the output imaging data includes: receiving a target region selection, wherein the target region selection is indicative of a target region of the first imaging data; tagging the target region with metadata indicative of the location of the target region; applying the first imaging data associated with the target region to the trained neural network to generate a corresponding target region of the output imaging data; tagging the corresponding target region of the output imaging data with the metadata associated with the target region; and positioning the corresponding target region of the output imaging data based at least in part on the metadata.
Example 13 is the system of example(s) 1-12, wherein the operations further include identifying a plurality of variation regions associated with the sample, wherein training the neural network and generating the output is associated with a first variation region and is performed using first subsets of the first imaging data and the second imaging data associated with the first variation region, and wherein the operations further include: training a second neural network based at least in part on second subsets of the first imaging data and the second imaging data associated with a second variation region; generating second output imaging data associated with the second variation region by applying the trained second neural network to the subset of the first imaging data associated with the second variation region; and stitching together the output imaging data and the second output imaging data.
Example 14 is the system of example(s) 1-13, wherein the operations further comprise generating a two-dimensional image or three-dimensional volume using the output imaging data.
Example 15 is the system of example(s) 14, wherein the generated two-dimensional image or three-dimensional volume is generated using the output imaging data and the first imaging data such that at least a region of the two-dimensional image or three-dimensional volume is based on the output imaging data and at least a different region of the two-dimensional image or three-dimensional volume is based on the first imaging data.
Example 16 is the system of example(s) 1-15, wherein generating the output imaging data includes applying the trained neural network to the first imaging data.
Example 17 is a method comprising: receiving first imaging data associated with a sample, the first imaging data acquired using a first imaging modality; receiving second imaging data associated with the sample, the second imaging data acquired using a second imaging modality that is different than the first imaging modality; aligning the first imaging data and the second imaging data; identifying a portion of the first imaging data overlapping with the second imaging data; training a neural network based at least in part on the portion of the first imaging data and the second imaging data; and generating output imaging data by applying the trained neural network to the first imaging data or a third imaging data acquired using the first imaging modality.
Example 18 is the method of example(s) 17, wherein the first imaging data is associated with a first image quality, wherein the second imaging data is associated with a second image quality, and wherein the output imaging data is associated with a third image quality that is improved with respect to the first image quality.
Example 19 is the method of example(s) 18, wherein the first image quality is associated with a first objective measurement, wherein the second image quality is associated with a second objective measurement, and wherein the third image quality is associated with a third objective measurement that is i) between the first objective measurement and the second objective measurement, or ii) the same as the second objective measurement.
Example 20 is the method of example(s) 17-19, wherein the first imaging data is acquired at a first resolution and first field of view, wherein the second imaging data is acquired at a second resolution that is higher than the first resolution and a second field of view that is smaller than the first field of view, and wherein the output imaging data has a higher resolution than the first resolution.
Example 21 is the method of example(s) 17-20, wherein the first imaging modality and the second imaging modality share a common major imaging modality.
Example 22 is the method of example(s) 17-20, wherein the first imaging modality includes a first major imaging modality that is X-ray microscopy, and wherein the second imaging modality includes a second major imaging modality that is not X-ray microscopy.
Example 23 is the method of example(s) 17-22, wherein aligning the first imaging data and the second imaging data includes automatically applying a 3, 6, or 9 degree of freedom sub-pixel alignment to at least one of the first imaging data and the second imaging data to align the first imaging data and the second imaging data.
Example 24 is the method of example(s) 17-23, further comprising resampling at least a portion of the first imaging data onto a grid of the second imaging data.
Example 25 is the method of example(s) 17-24, wherein training the neural network includes: providing the portion of the first imaging data associated with the second imaging data to the neural network to generate the output data; and adjusting the neural network to reduce a difference between the generated output data and the second imaging data.
Example 26 is the method of example(s) 17-25, wherein generating the output imaging data includes: applying a zoom transform to the first imaging data to achieve an effective pixel size equal to the pixel size of the second imaging data; applying the transformed first imaging data to the trained neural network to generate the output imaging data.
Example 27 is the method of example(s) 17-26, wherein generating the output imaging data includes: segmenting the first imaging data into a plurality of chunks, wherein each chunk includes at least one overlapping region with an adjacent chunk; applying each of the plurality of chunks of the first imaging data to the trained neural network to generate a corresponding chunk of the output imaging data; and stitching together the overlapping regions of the corresponding chunks of the output imaging data.
Example 28 is the method of example(s) 17-27, wherein generating the output imaging data includes: receiving a target region selection, wherein the target region selection is indicative of a target region of the first imaging data; tagging the target region with metadata indicative of the location of the target region; applying the first imaging data associated with the target region to the trained neural network to generate a corresponding target region of the output imaging data; tagging the corresponding target region of the output imaging data with the metadata associated with the target region; and positioning the corresponding target region of the output imaging data based at least in part on the metadata.
Example 29 is the method of example(s) 17-28, further comprising identifying a plurality of variation regions associated with the sample, wherein training the neural network and generating the output is associated with a first variation region and is performed using first subsets of the first imaging data and the second imaging data associated with the first variation region, and wherein the method further comprises: training a second neural network based at least in part on second subsets of the first imaging data and the second imaging data associated with a second variation region; generating second output imaging data associated with the second variation region by applying the trained second neural network to the subset of the first imaging data associated with the second variation region; and stitching together the output imaging data and the second output imaging data.
Example 30 is the method of example(s) 17-29, further comprising generating a two-dimensional image or three-dimensional volume using the output imaging data.
Example 31 is the method of example(s) 30, wherein the generated two-dimensional image or three-dimensional volume is generated using the output imaging data and the first imaging data such that at least a region of the two-dimensional image or three-dimensional volume is based on the output imaging data and at least a different region of the two-dimensional image or three-dimensional volume is based on the first imaging data.
Example 32 is the method of example(s) 17-31, wherein generating the output imaging data includes applying the trained neural network to the first imaging data.
Example 33 is a computer-program product tangibly embodied in a non-transitory machine-readable storage medium, including instructions configured to cause a data processing apparatus to perform operations including: receiving first imaging data associated with a sample, the first imaging data acquired using a first imaging modality; receiving second imaging data associated with the sample, the second imaging data acquired using a second imaging modality that is different than the first imaging modality; aligning the first imaging data and the second imaging data; identifying a portion of the first imaging data overlapping with the second imaging data; training a neural network based at least in part on the portion of the first imaging data and the second imaging data; and generating output imaging data by applying the trained neural network to the first imaging data or a third imaging data acquired using the first imaging modality.
Example 34 is the computer-program product of example(s) 33, wherein the first imaging data is associated with a first image quality, wherein the second imaging data is associated with a second image quality, and wherein the output imaging data is associated with a third image quality that is improved with respect to the first image quality.
Example 35 is the computer-program product of example(s) 34, wherein the first image quality is associated with a first objective measurement, wherein the second image quality is associated with a second objective measurement, and wherein the third image quality is associated with a third objective measurement that is i) between the first objective measurement and the second objective measurement, or ii) the same as the second objective measurement.
Example 36 is the computer-program product of example(s) 33-35, wherein the first imaging data is acquired at a first resolution and first field of view, wherein the second imaging data is acquired at a second resolution that is higher than the first resolution and a second field of view that is smaller than the first field of view, and wherein the output imaging data has a higher resolution than the first resolution.
Example 37 is the computer-program product of example(s) 33-36, wherein the first imaging modality and the second imaging modality share a common major imaging modality.
Example 38 is the computer-program product of example(s) 33-36, wherein the first imaging modality includes a first major imaging modality that is X-ray microscopy, and wherein the second imaging modality includes a second major imaging modality that is not X-ray microscopy.
Example 39 is the computer-program product of example(s) 33-38, wherein aligning the first imaging data and the second imaging data includes automatically applying a 3, 6, or 9 degree of freedom sub-pixel alignment to at least one of the first imaging data and the second imaging data to align the first imaging data and the second imaging data.
Example 40 is the computer-program product of example(s) 33-39, wherein the operations further comprise resampling at least a portion of the first imaging data onto a grid of the second imaging data.
Example 41 is the computer-program product of example(s) 33-40, wherein training the neural network includes: providing the portion of the first imaging data associated with the second imaging data to the neural network to generate the output data; and adjusting the neural network to reduce a difference between the generated output data and the second imaging data.
Example 42 is the computer-program product of example(s) 33-41, wherein generating the output imaging data includes: applying a zoom transform to the first imaging data to achieve an effective pixel size equal to the pixel size of the second imaging data; applying the transformed first imaging data to the trained neural network to generate the output imaging data.
Example 43 is the computer-program product of example(s) 33-42, wherein generating the output imaging data includes: segmenting the first imaging data into a plurality of chunks, wherein each chunk includes at least one overlapping region with an adjacent chunk;

applying each of the plurality of chunks of the first imaging data to the trained neural network to generate a corresponding chunk of the output imaging data; and stitching together the overlapping regions of the corresponding chunks of the output imaging data.
Example 44 is the computer-program product of example(s) 33-43, wherein generating the output imaging data includes: receiving a target region selection, wherein the target region selection is indicative of a target region of the first imaging data; tagging the target region with metadata indicative of the location of the target region; applying the first imaging data associated with the target region to the trained neural network to generate a corresponding target region of the output imaging data; tagging the corresponding target region of the output imaging data with the metadata associated with the target region; and positioning the corresponding target region of the output imaging data based at least in part on the metadata.
Example 45 is the computer-program product of example(s) 33-44, wherein the operations further include identifying a plurality of variation regions associated with the sample, wherein training the neural network and generating the output is associated with a first variation region and is performed using first subsets of the first imaging data and the second imaging data associated with the first variation region, and wherein the operations further include: training a second neural network based at least in part on second subsets of the first imaging data and the second imaging data associated with a second variation region; generating second output imaging data associated with the second variation region by applying the trained second neural network to the subset of the first imaging data associated with the second variation region; and stitching together the output imaging data and the second output imaging data.
Example 46 is the computer-program product of example(s) 33-45, wherein the operations further comprise generating a two-dimensional image or three-dimensional volume using the output imaging data.
Example 47 is the computer-program product of example(s) 46, wherein the generated two-dimensional image or three-dimensional volume is generated using the output imaging data and the first imaging data such that at least a region of the two-dimensional image or three-dimensional volume is based on the output imaging data and at least a different region of the two-dimensional image or three-dimensional volume is based on the first imaging data.
Example 48 is the computer-program product of example(s) 33-47, wherein generating the output imaging data includes applying the trained neural network to the first imaging data.

1. A system, comprising:
one or more data processors; and
a non-transitory computer-readable storage medium containing instructions which, when executed on the one or more data processors, cause the one or more data processors to perform operations including:
receiving first imaging data associated with a sample, the first imaging data acquired using a first imaging modality;
receiving second imaging data associated with the sample, the second imaging data acquired using a second imaging modality that is different than the first imaging modality;
aligning the first imaging data and the second imaging data;
identifying a portion of the first imaging data overlapping with the second imaging data;
training a neural network based at least in part on the portion of the first imaging data and the second imaging data; and
generating output imaging data by applying the trained neural network to the first imaging data or a third imaging data that is acquired using the first imaging modality.

2-3. (canceled)

4. The system of claim 1, wherein the first imaging data is acquired at a first resolution and first field of view, wherein the second imaging data is acquired at a second resolution that is higher than the first resolution and a second field of view that is smaller than the first field of view, and wherein the output imaging data has a higher resolution than the first resolution.

5-9. (canceled)

10. The system of claim 1, wherein generating the output imaging data includes:
applying a zoom transform to the first imaging data to achieve an effective pixel size equal to the pixel size of the second imaging data;
applying the transformed first imaging data to the trained neural network to generate the output imaging data.

11-16. (canceled)

17. A method comprising:
receiving first imaging data associated with a sample, the first imaging data acquired using a first imaging modality;
receiving second imaging data associated with the sample, the second imaging data acquired using a second imaging modality that is different than the first imaging modality;
aligning the first imaging data and the second imaging data;
identifying a portion of the first imaging data overlapping with the second imaging data;
training a neural network based at least in part on the portion of the first imaging data and the second imaging data; and
generating output imaging data by applying the trained neural network to the first imaging data or a third imaging data acquired using the first imaging modality.

18. The method of claim 17, wherein the first imaging data is associated with a first image quality, wherein the second imaging data is associated with a second image quality, and wherein the output imaging data is associated with a third image quality that is improved with respect to the first image quality.

19. The method of claim 18, wherein the first image quality is associated with a first objective measurement, wherein the second image quality is associated with a second objective measurement, and wherein the third image quality is associated with a third objective measurement that is i) between the first objective measurement and the second objective measurement, or ii) the same as the second objective measurement.

20. The method of claim 17, wherein the first imaging data is acquired at a first resolution and first field of view, wherein the second imaging data is acquired at a second resolution that is higher than the first resolution and a second field of view that is smaller than the first field of view, and wherein the output imaging data has a higher resolution than the first resolution.

21. The method of claim 17, wherein the first imaging modality and the second imaging modality share a common major imaging modality.

22. The method of claim 17, wherein the first imaging modality includes a first major imaging modality that is X-ray microscopy, and wherein the second imaging modality includes a second major imaging modality that is not X-ray microscopy.

23. The method of claim 17, wherein aligning the first imaging data and the second imaging data includes automatically applying a 3, 6, or 9 degree of freedom sub-pixel alignment to at least one of the first imaging data and the second imaging data to align the first imaging data and the second imaging data.

24. The method of claim 17, further comprising resampling at least a portion of the first imaging data onto a grid of the second imaging data.

25. The method of claim 17, wherein training the neural network includes:
providing the portion of the first imaging data associated with the second imaging data to the neural network to generate the output data; and
adjusting the neural network to reduce a difference between the generated output data and the second imaging data.

26. The method of claim 17, wherein generating the output imaging data includes:
applying a zoom transform to the first imaging data to achieve an effective pixel size equal to the pixel size of the second imaging data;
applying the transformed first imaging data to the trained neural network to generate the output imaging data.

27. The method of claim 17, wherein generating the output imaging data includes:
segmenting the first imaging data into a plurality of chunks, wherein each chunk includes at least one overlapping region with an adjacent chunk;
applying each of the plurality of chunks of the first imaging data to the trained neural network to generate a corresponding chunk of the output imaging data; and
stitching together the overlapping regions of the corresponding chunks of the output imaging data.

28. The method of claim 17, wherein generating the output imaging data includes:
receiving a target region selection, wherein the target region selection is indicative of a target region of the first imaging data;
tagging the target region with metadata indicative of the location of the target region;
applying the first imaging data associated with the target region to the trained neural network to generate a corresponding target region of the output imaging data;
tagging the corresponding target region of the output imaging data with the metadata associated with the target region; and
positioning the corresponding target region of the output imaging data based at least in part on the metadata.

29. The method of claim 17, further comprising identifying a plurality of variation regions associated with the sample, wherein training the neural network and generating the output is associated with a first variation region and is performed using first subsets of the first imaging data and the second imaging data associated with the first variation region, and wherein the method further comprises:
training a second neural network based at least in part on second subsets of the first imaging data and the second imaging data associated with a second variation region;
generating second output imaging data associated with the second variation region by applying the trained second neural network to the subset of the first imaging data associated with the second variation region; and
stitching together the output imaging data and the second output imaging data.

30. The method of claim 17, further comprising generating a two-dimensional image or three-dimensional volume using the output imaging data.

31. The method of claim 30, wherein the generated two-dimensional image or three-dimensional volume is generated using the output imaging data and the first imaging data such that at least a region of the two-dimensional image or three-dimensional volume is based on the output imaging data and at least a different region of the two-dimensional image or three-dimensional volume is based on the first imaging data.

32. The method of claim 17, wherein generating the output imaging data includes applying the trained neural network to the first imaging data.

33. A computer-program product tangibly embodied in a non-transitory machine-readable storage medium, including instructions configured to cause a data processing apparatus to perform operations including:
receiving first imaging data associated with a sample, the first imaging data acquired using a first imaging modality;
receiving second imaging data associated with the sample, the second imaging data acquired using a second imaging modality that is different than the first imaging modality;
aligning the first imaging data and the second imaging data;
identifying a portion of the first imaging data overlapping with the second imaging data;
training a neural network based at least in part on the portion of the first imaging data and the second imaging data; and
generating output imaging data by applying the trained neural network to the first imaging data or a third imaging data acquired using the first imaging modality.

34-48. (canceled)
